(19) United States
(12) Patent Application Publication
(10) Pub. No.: US 2016/0206128 A1
(43) Pub. Date: Jul. 21, 2016

(54) WIRELESSLY CONTROLLABLE CURTAIN SYSTEM AND CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: KAI-LE ZHAI, Wuhan (CN); CHUN-SHENG CHEN, New Taipei (TW)

(21) Appl. No.: 14/611,972

(22) Filed: Feb. 2, 2015

(30) Foreign Application Priority Data
Jan. 15, 2015 (CN) 201510020018.2

(51) Int. Cl. A47H 5/02; G05B 15/02; G08C 17/02

(52) U.S. Cl. CPC A47H 5/02; G08C 17/02; G05B 15/02; A47H 2005/025

(57) ABSTRACT

A wirelessly controllable curtain system includes wireless control and operation systems. The wireless control system includes a wireless control module and a wireless sending module. The wireless operation system is coupled to a curtain and has a wireless receiving module coupled to the wireless control module, a motor controller, and a motor. The wireless control module is configured to send an open/close control signal to the wireless sending module for on passing to the wireless receiving module. The wireless receiving module is configured to send an operation signal, corresponding to the open/close control signal, to the motor controller. The motor rotates in one direction or in the opposite direction to open or close the curtain according to the operation signal. A wirelessly controllable curtain circuit is also provided.

### FIELD

The subject matter herein generally relates to lighting and environmental control.

### BACKGROUND

A curtain is generally used in a window to adjust room light. Generally, the curtain is opened or closed manually.

### BRIEF DESCRIPTION OF THE DRAWINGS

Implementations of the present technology will now be described, by way of example only, with reference to the attached figures.

FIG. 1 is a block diagram of an embodiment of a wirelessly controllable curtain system and a curtain.

FIG. 2 is a block diagram of an embodiment of a wirelessly controllable curtain circuit.

FIG. 3 is a circuit diagram of a wireless receiving circuit, a motor control circuit, and a motor circuit of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

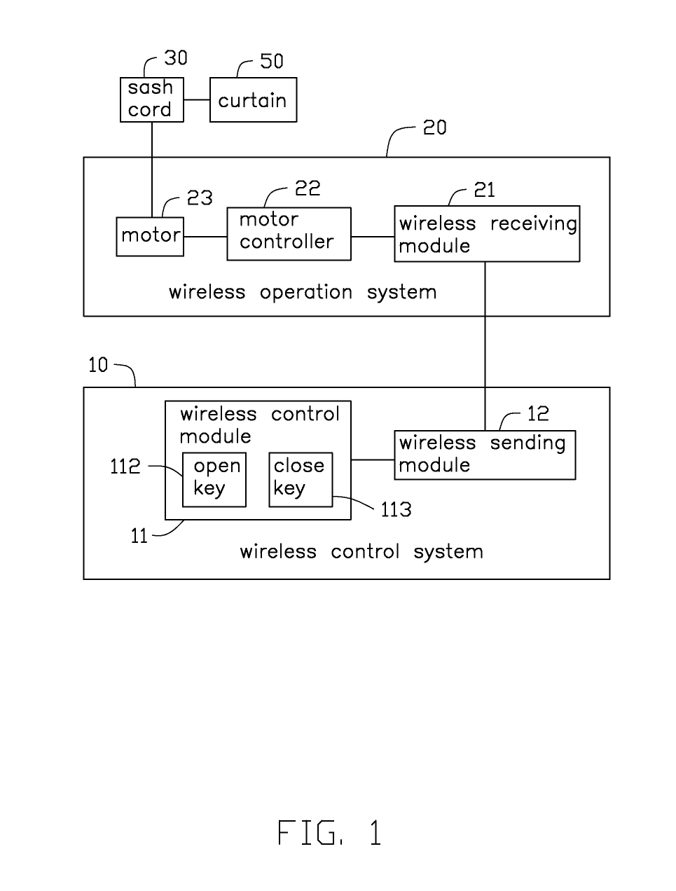

FIG. 1 illustrates a wirelessly controllable curtain system in accordance with an embodiment. The wirelessly controllable curtain system can include a wireless control system 10 and a wireless operation system 20. The wireless operation system 20 is coupled to a curtain 50 through a sash cord 30. The wireless control system 10 is configured to send a control signal to the wireless operation system 20 to pull the curtain 50 back or pull the curtain closed, via the sash cord 30. The wireless control system 10 can be positioned in a place away from the curtain 50, such as bedside, sofa, or dining table.

The wireless control system 10 can include a wireless control module 11 and a wireless sending module 12. The wireless control module 11 has an open key 112 and a close key 113. Each of the open key 112 and the close key 113 is an entity or virtual key.

The wireless operation system 20 can include a wireless receiving module 21, a motor controller 22, and a motor 23. The wireless receiving module 21 is coupled to the wireless sending module 12 wirelessly, such as by infrared ray, BLUETOOTH, or WIFI. The motor controller 22 is coupled to the motor 23 to control a rotating direction of the motor 23. The sash cord 30 is secured to rotating ports of the motor 23.

When the open key 112 is selected, the wireless control module 11 sends an open control signal to the wireless sending module 12. The wireless sending module 12 launches the open control signal to the wireless receiving module 21. The wireless receiving module 21 sends a first operation signal to the motor controller 22. The motor controller 22 controls the motor 23 to rotate in a first direction according to the first operation signal. The motor 23 pulls the sash cord 30 to open the curtain 50.

When the close key 113 is selected, the wireless control module 11 sends a close control signal to the wireless sending module 12. The wireless sending module 12 launches the close control signal to the wireless receiving module 21. The wireless receiving module 21 sends a second operation signal to the motor controller 22. The motor controller 22 controls the motor 23 to rotate in a second direction, opposite to the first direction, according to the second operation signal. The motor 23 pulls the sash cord 30 to close the curtain 50.

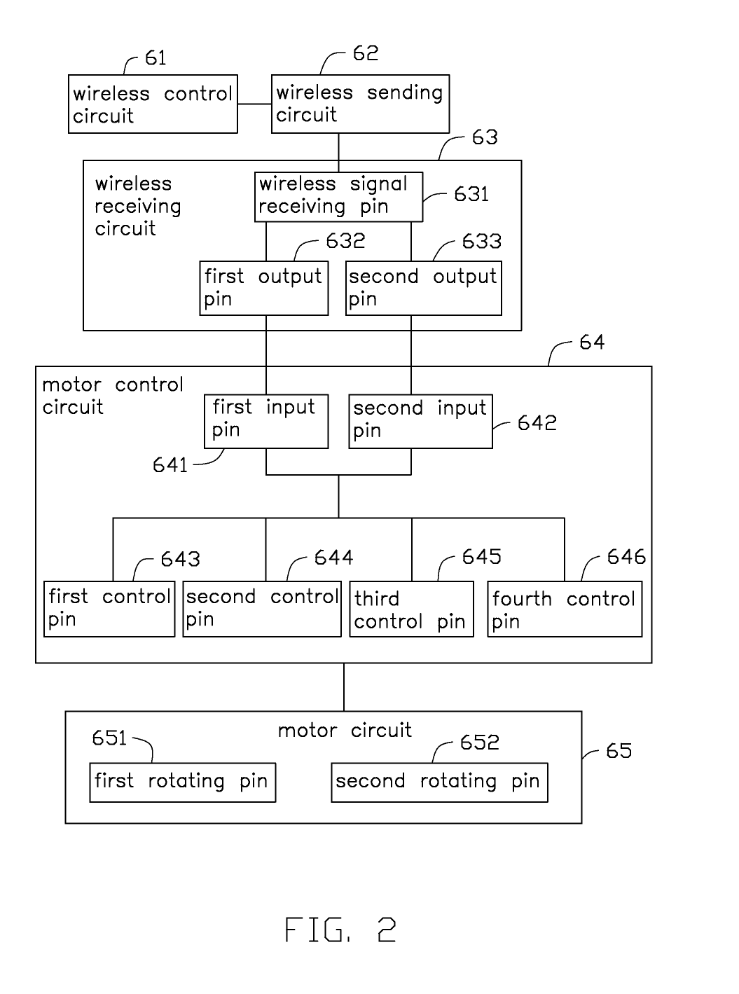

FIG. 2 illustrates a wirelessly controllable curtain circuit in accordance with an embodiment. The wirelessly controllable curtain circuit can include a wireless control circuit 61, a wireless sending circuit 62, a wireless receiving circuit 63, a motor control circuit 64, and a motor circuit 65.

The wireless control circuit 61 is configured to send the open or close control signal to the wireless sending circuit 62. The wireless sending circuit 62 is configured to launch the open or close control signal.

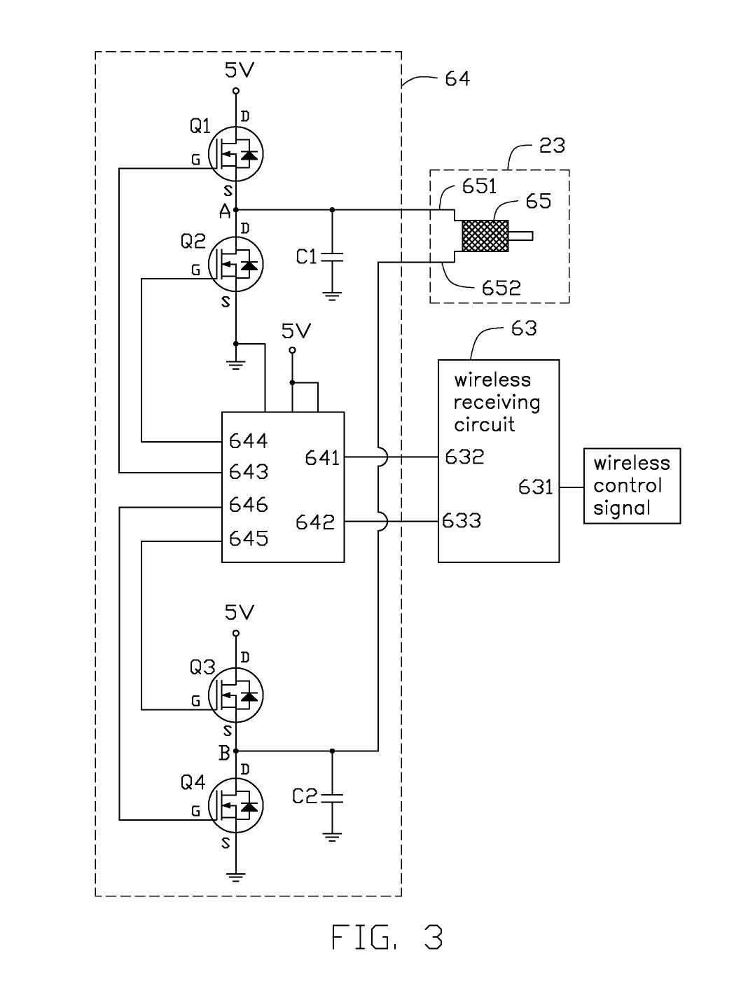

FIG. 3 illustrates that the wireless receiving circuit 63 can include a wireless signal receiving pin 631, a first output pin 632, and a second output pin 633. The wireless signal receiving pin 631 is configured to receive the open and close control signals. When the wireless signal receiving pin 631 receives the open control signal, the first output pin 632 outputs a high level voltage signal (indicated by 1) and the second output pin 633 outputs a low level voltage signal (indicated by 0). The wireless receiving circuit 63 then sends a first operation signal 10 to the motor control circuit 64. When the wireless signal receiving pin 631 receives the close control signal, the first output pin 632 outputs a low level voltage signal (indicated by 0) and the second output pin 633 outputs a high level voltage signal (indicated by 1). The wireless receiving circuit 63 then sends a second operation signal 01 to the motor control circuit 64.

The motor control circuit 64 can include a first input pin 641, a second input pin 642, a first control pin 643, a second control pin 644, a third control pin 645, a fourth control pin 646, a first field-effect tube (EFT) Q1, a second EFT Q2, a third EFT Q3, and a fourth EFT Q4. The first input pin 641 is coupled to the first output pin 632. The second input pin 642 is coupled to the second output pin 633. The first control pin 643, the second control pin 644, the third control pin 645, and the fourth control pin 646 are coupled to the grid electrode G of the first EFT Q1, the second EFT Q2, the third EFT Q3, and the fourth EFT Q4 respectively. The drain electrode D of each of the first FET Q1 and the second FET Q2 is coupled to a direct current power supply. The source electrode S of each of the third FET Q3 and the fourth FET Q4 is grounded. The source electrode S of the first FET Q1 is coupled to the drain electrode D of the second FET Q2. The source electrode S of the third FET Q3 is coupled to the drain electrode D of the fourth FET Q4. A first node A is defined between the source electrode S of the first FET Q1 and the drain electrode D of the second FET Q2. The first node A is grounded via a capacitor C1 and coupled to a first rotating pin 651 of the motor circuit 65. A second node B is defined between the source electrode S of the third FET Q3 and the drain electrode D of the fourth FET Q4. The second node B is grounded via a capacitor C2 and coupled to a second rotating pin 652 of the motor circuit 65.

When the motor control circuit 64 receives the first operation signal 10, the first input pin 641 has a high level voltage signal, and the second input pin 642 has a low level voltage signal. The first control pin 643, the second control pin 644, the third control pin 645, and the fourth control pin 646 respectively output a high level voltage signal, a low level voltage signal, a low voltage signal, and a high level voltage signal. Thus, the first FET Q1 and the fourth FET Q4 are switched on, and the second FET Q2 and the third FET Q3 are switched off. The first node A outputs a high level voltage signal, and the second node B outputs a low level voltage signal. The first rotating pin 651 receives the high level voltage signal, the second rotating pin 652 receives the low level voltage signal, and the motor 23 is rotated in the first direction.

When the motor control circuit 64 receives the second operation signal 01, the first input pin 641 has a low level voltage signal, and the second input pin 642 has a high level voltage signal. The first control pin 643, the second control pin 644, the third control pin 645, and the fourth control pin 646 respectively output a low level voltage signal, a high level voltage signal, a high voltage signal, and a low level voltage signal. Thus, the first FET Q1 and the fourth FET Q4 are switched off, and the second FET Q2 and the third FET Q3 are switched on. The first node A outputs a low level voltage signal, and the second node B outputs a high level voltage signal. The first rotating pin 651 receives the low level voltage signal, the second rotating pin 652 receives the high level voltage signal, and the motor 23 is rotated in the second direction.

When the motor 23 is rotated in the first direction, the sash cord 30 is pulled to open the curtain 50, and when the motor 23 is rotated in the second direction, the sash cord 30 is pulled to close the curtain 50.

The embodiments shown and described above are only examples. Many details are often found in the art such as the other features of a wirelessly controllable curtain system and circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A wirelessly controllable curtain system comprising:
a wireless control system having:
a wireless control module and a wireless sending module coupled to the wireless control module; and
a wireless operation system configured to couple a curtain and having:
a wireless receiving module coupled to the wireless control module, a motor controller coupled to the wireless receiving module, and a motor coupled to the motor controller;
wherein the wireless control module is configured to send an open/close control signal to the wireless sending module; the wireless sending module is configured to launch the open/close control signal to the wireless receiving module; the wireless receiving module is configured to send an operation signal, corresponding to the open/close control signal, to the motor controller;
and the motor is configured to rotate in a corresponding direction to open or close the curtain according to the operation signal.

2. The wirelessly controllable curtain system of claim 1, wherein the wireless control module has an open key and a close key, each of the open key and the close key is selectable to send the open/close control signal to the wireless sending module.

3. The wirelessly controllable curtain system of claim 2, wherein each of the open key and the close key is an entity or virtual key.

4. The wirelessly controllable curtain system of claim 1, further comprising a sash cord coupled to a rotating end of the motor, wherein the motor is configured to pull the curtain through the sash cord.

5. A wirelessly controllable curtain circuit comprising:
a wireless control circuit;
a wireless sending circuit coupled to the wireless control circuit;
a wireless receiving circuit coupled to the wireless control circuit;
a motor control circuit coupled to the wireless receiving circuit; and
a motor circuit coupled to the motor control circuit;
wherein the wireless control circuit is configured to send an open/close control signal to the wireless sending circuit; the wireless sending circuit is configured to launch the open/close control signal to the wireless receiving circuit; the wireless receiving circuit is configured to send an operation signal, corresponding to the open/close control signal, to the motor control circuit;
and the motor circuit is configured to rotate in a corresponding direction to open or close the curtain according to the operation signal.

6. The wirelessly controllable curtain circuit of claim 5, wherein the wireless receiving circuit comprises a wireless signal receiving pin, a first output pin, and a second output pin; the wireless signal receiving pin is configured to receive the open and close control signal; when the wireless signal receiving pin receives the open control signal, the first output pin outputs a high level voltage signal, and the second output pin outputs a low level voltage signal; and when the wireless signal receiving pin receives the close control signal, the first output pin outputs a low level voltage signal, and the second output pin outputs a high level voltage signal.

7. The wirelessly controllable curtain circuit of claim 6, wherein motor control circuit comprises a first input pin, a second input pin, a first control pin, a second control pin, a third control pin, a fourth control pin, a first field-effect tube (EFT), a second EFT, a third EFT, and a fourth EFT;
the first input pin is coupled to the first output pin; the second input pin is coupled to the second output pin; the first control pin, the second control pin, the third control pin, and the fourth control pin are coupled to the grid electrode of the first EFT, the second EFT, the third EFT, and the fourth EFT respectively.

8. The wirelessly controllable curtain circuit of claim 7, wherein the drain electrode of each of the first FET and the second FET is coupled to a direct current power; the source electrode of each of the third FET and the fourth FET is grounded; the source electrode of the first FET is coupled to the drain electrode of the second FET; and the source electrode of the third FET is coupled to the drain electrode of the fourth FET.

9. The wirelessly controllable curtain circuit of claim 8, wherein a first node is defined between the source electrode of the first FET and the drain electrode of the second FET, and the first node is grounded via a first capacitor and coupled to a first rotating pin of the motor circuit; and a second node is defined between the source electrode of the third FET and the drain electrode of the fourth FET, and the second node is grounded via a second capacitor and coupled to a second rotating pin of the motor circuit.

10. The wirelessly controllable curtain circuit of claim 9, wherein when the first input pin has a high level voltage signal, and the second input pin has a low level voltage signal, the first control pin, the second control pin, the third control pin, and the fourth control pin output a high level voltage signal, a low level voltage signal, a low voltage signal, and a high level voltage signal respectively; the first FET and the fourth FET are switched on, and the second FET and the third FET are switched off; the first node outputs a high level voltage signal, and the second node outputs a low level voltage signal, and the motor is rotated in a first direction; and when the first input pin has a low level voltage signal, and the second input pin has a high level voltage signal, the first control pin, the second control pin, the third control pin, and the fourth control pin output a low level voltage signal, a high level voltage signal, a high voltage signal, and a low level voltage signal respectively; the first FET and the fourth FET are switched off, and the second FET and the third FET are switched on; the first node outputs a low level voltage signal, the second node outputs a high level voltage signal, and the motor is rotated in a second direction opposite to the first direction.

11. A wirelessly controllable curtain circuit comprising:
a wireless control circuit;
a wireless sending circuit coupled to the wireless control circuit;
a wireless receiving circuit coupled to the wireless control circuit;
a motor control circuit coupled to the wireless receiving circuit and comprising a plurality of control pins each coupled to a FET; and
a motor circuit coupled to the plurality of control pins;
wherein the wireless control circuit is configured to send an open/close control signal to the wireless sending circuit; the wireless sending circuit is configured to launch the open/close control signal to the wireless receiving circuit; the wireless receiving circuit is configured to send an operation signal, corresponding to the open/close control signal, to the motor control circuit;
the plurality of control pins are configured to control the FETs to switch on or off, according to the operation signal, to control the motor circuit to rotate in a corresponding direction to open or close the curtain.

12. The wirelessly controllable curtain circuit of claim 11, wherein the wireless receiving circuit comprises a wireless signal receiving pin, a first output pin, and a second output pin; the wireless signal receiving pin is configured to receive the open and close control signal; when the wireless signal receiving pin receives the open control signal, the first output pin outputs a high level voltage signal, and the second output pin outputs a low level voltage signal; and when the wireless signal receiving pin receives the close control signal, the first output pin outputs a low level voltage signal, and the second output pin outputs a high level voltage signal.

13. The wirelessly controllable curtain circuit of claim 12, wherein motor control circuit further comprises a first input pin, a second input pin, a first control pin, a second control pin, a third control pin, a fourth control pin, a first field-effect tube (EFT), a second EFT, a third EFT, and a fourth EFT; the first input pin is coupled to the first output pin; the second input pin is coupled to the second output pin; the first control pin, the second control pin, the third control pin, and the fourth control pin are coupled to the grid electrode of the first EFT, the second EFT, the third EFT, and the fourth EFT respectively.

14. The wirelessly controllable curtain circuit of claim 13, wherein the drain electrode of each of the first FET and the second FET is coupled to a direct current power; the source electrode of each of the third FET and the fourth FET is grounded; the source electrode of the first FET is coupled to the drain electrode of the second FET; and the source electrode of the third FET is coupled to the drain electrode of the fourth FET.

15. The wirelessly controllable curtain circuit of claim 14, wherein a first node is defined between the source electrode of the first FET and the drain electrode of the second FET, and the first node is grounded via a first capacitor and coupled to a first rotating pin of the motor circuit;
and a second node is defined between the source electrode of the third FET and the drain electrode of the fourth FET, and the second node is grounded via a second capacitor and coupled to a second rotating pin of the motor circuit.

16. The wirelessly controllable curtain circuit of claim 15, wherein when the first input pin has a high level voltage signal, and the second input pin has a low level voltage signal, the first control pin, the second control pin, the third control pin, and the fourth control pin output a high level voltage signal, a low level voltage signal, a low voltage signal, and a high level voltage signal respectively; the first FET and the fourth FET are switched on, and the second FET and the third FET are switched off; the first node outputs a high level voltage signal, and the second node outputs a low level voltage signal, and the motor is rotated in a first direction; and when the first input pin has a low level voltage signal, and the second input pin has a high level voltage signal, the first control pin, the second control pin, the third control pin, and the fourth control pin output a low level voltage signal, a high level voltage signal, a high voltage signal, and a low level voltage signal respectively; the first FET and the fourth FET are switched off, and the second FET and the third FET are switched on; the first node outputs a low level voltage signal, the second node outputs a high level voltage signal, and the motor is rotated in a second direction opposite to the first direction.
